(19) United States
(12) Patent Application Publication
(10) Pub. No.: US 2015/0219254 A1
(43) Pub. Date: Aug. 6, 2015

(54) PIPE CONNECTION APPARATUS AND PIPE CONNECTION METHOD

(71) Applicant: LORDO H CO., LTD., Gyeonggi-do (KR)

(72) Inventors: Jun Bae Lee, Seoul (KR); Won Sik Hong, Seoul (KR); Kyung Wook Ahn, Anyang-si (KR)

(21) Appl. No.: 14/427,281

(22) PCT Filed: Jan. 3, 2013
(86) PCT No.: PCT/KR2013/000026

§ 371 Date: Mar. 10, 2015

(30) Foreign Application Priority Data
Dec. 4, 2012 (KR) 10-2012-0139645

(51) Int. Cl. F16L 13/10; F16L 47/02; F16L 47/24; F16L 13/11

(52) U.S. Cl. CPC F16L 13/103; F16L 13/116; F16L 47/02; F16L 47/24

(57) ABSTRACT

The present invention relates to a pipe connection device and a pipe connection method, wherein binding force is maintained by a polymer bonder for coupling with a metal material through ion substitution by moltenization between a fitting cover through hole of both ends of a metal material and a coupling pipe. Therefore, a connection of metallic pipes and a mutual coupling construction of plastic composite pipes can be readily carried out by using the polymer bonder which has a low cost and is coupled with the metal material through ion substitution. Additionally, a use under a high pressure condition is possible.

### BACKGROUND OF THE INVENTION

1. Field of the Invention

The present invention relates to a pipe connection apparatus and a pipe connection method, and more particularly to a pipe connection apparatus and a pipe connection method in which metallic pipes are connected by using a polymer bonder which is inexpensive and ion-substitution bonded to a metal material and plastic complex pipes are easily coupled to each other, and which can be used in a high pressure environment.

2. Description of the Prior Art

As well known in many documents, connection of metallic pipes are made by using a plurality of connection apparatuses, or a gasket is inserted between flanges formed at ends of the metallic pipes to be coupled by bolts and nuts.

A copper pipe used as a refrigerant pipe of an air conditioning apparatus may be directly welded to a seaming apparatus.

In recent years, although purposes and environments thereof have been extremely limited, pipe connecting adhesives have been released such that neighboring pipes are connected to each other by the adhesives.

The complex pipes are being increasingly used as a replacement of copper pipes, and have several layers of polymers and metals.

However, the complex pipes are not equipped with a dedicated connection apparatus, so that an existing apparatus for connecting metallic pipes has been improved to be used or an existing connection apparatus including a general coupling is used when it is used as a low pressure pipe.

The pipe connection apparatuses include a plurality of complicated metal parts, and thus are expensive. In addition, their coupling operations are not simple so that the operator has many operations to do.

Further, the pipe connection apparatuses directly include a welder for connection of copper pipes used for a high pressure refrigerant, which requires a welding process.

In addition, the pipe connection apparatuses require much time for an adhesive to be completely solidified and their in-use pressure is limited.

For this reason, because connection of pipes formed of dissimilar materials cannot be made in the field, only pipes formed of the same material are coupled to each other.

### SUMMARY OF THE INVENTION

The present invention has been made in an effort to solve the above-described problems, and provides a pipe connection apparatus and a pipe connection method, in which metallic pipes are connected by using a polymer bonder which is inexpensive and ion-substitution bonded to a metal material and plastic complex pipes are easily coupled to each other, and which can be used in a high pressure environment.

In order to achieve the above object, there is provided a pipe connection apparatus including: a metallic fitting cover, opposite ends of which are communication with each other; a cover protrusion protruding along an outer peripheral surface of the fitting cover; coupling pipes inserted into opposite ends of the fitting cover, respectively, passages of which are connected to each other by the fitting cover, having an outer diameter smaller than an inner diameter of the fitting cover, and formed of a composite material of a metal and a synthetic resin or a metal; and polymer bonders disposed between the fitting cover and the coupling pipes, respectively, for fastening the fitting cover and the coupling pipes while being fused to be activated such that ions of the polymer bonders are ion-substitution bonded to metal ions on an inner peripheral surface of the fitting cover and outer surfaces of the coupling pipes.

The cover protrusion is formed at an intermediate portion of the fitting cover, the coupling pipes are inserted into the fitting cover from opposite ends of the fitting cover and are coupled to the fitting cover, and the polymer bonders are coupled to ends of the coupling pipes and are inserted into the fitting cover from the opposite ends of the fitting cover.

The pipe connection apparatus further includes first tapered introduction parts formed by cutting inner peripheral surfaces of opposite ends of the fitting cover such that the first tapered introduction parts are inclined toward the cover protrusion.

The fitting cover further includes a first rib stopper disposed at a location corresponding to the cover protrusion and protruding along an inner peripheral surface of the fitting cover.

Each of the polymer bonders includes: a cylindrical bonder body surrounding an end of the corresponding coupling pipe and opposite ends of which are communicated with each other; and a bonder stopper extending from a periphery of an end of the bonder body such that an end of the corresponding coupling pipe is caught by and fixed to the bonder stopper.

The pipe connection apparatus further includes intermediate bushings attached and coupled to an outer surface of the polymer bodies, wherein the outer peripheral surfaces of the intermediate bushings are attached to the inner peripheral surface of the fitting cover.

The cover protrusion is formed at an end of the fitting cover, the coupling pipes are inserted into the fitting cover from opposite ends of the fitting cover and are coupled to the fitting cover, and the polymer bonders are coupled to surround outer peripheral surfaces of the coupling pipes, respectively.

The pipe connection apparatus further includes: a second tapered part formed by cutting an inner peripheral surface of one end of the fitting cover such that the second tapered part is inclined toward the cover protrusion; and a second rib stopper protruding along an inner peripheral surface of an opposite end of the fitting cover.

The pipe connection apparatus further includes: an inner fitting connecting ends of the coupling pipes which face each other and including a third rib stopper protruding along an outer peripheral surface of the intermediate portion.

In each of the polymer bonders, particles of a polar medium are dispersed in a Methyl Meta Acrylate (NMA) butadiene rubber based resin.

The polar medium includes one of or at least one combination of Meth-Acrylate (MA), Vinyl Acetate (VA), Maleic Anhydride (MA), and Methyl Meth-Acrylate (NMA).

The polymer bonders are band-shaped bonder tapes wound on outer peripheral surfaces of the coupling pipes a plurality of times.

Each of the polymer bonders further includes an adhesive layer having at least one line or a plurality of points formed along a lengthwise direction of the bonder tape.

The fitting cover includes one of or at least one combination of aluminum, an aluminum alloy, copper, a copper alloy, titanium, a titanium alloy, steel, a steel alloy, magnesium, and a magnesium alloy.

In accordance with another aspect of the present invention, there is provided a pipe connection method including the steps of: (1) coupling polymer bonders to ends of a coupling pipe; (2) inserting the ends of the coupling pipes to which the polymer bonders are coupled into opposite ends of a metallic fitting cover, ends of which are communicated with each other, and attaching the polymer bonders between outer peripheral surfaces of the coupling pipes and an inner peripheral surface of the fitting cover; and (3) fusing and activating the polymer bonders by applying heat to an outer peripheral surface of the fitting cover, and fastening the fitting cover and the coupling pipes if metal ions on the inner surface of the fitting cover and the outer peripheral surfaces of the coupling pipes and ions constituting the polymer bonders are ion-substitution bonded to each other.

In accordance with another aspect of the present invention, there is provided a pipe connection method including the steps of: (1) passing a metallic fitting cover through an end of a coupling pipe, and coupling a polymer bonder to an end of the coupling pipe; (2) inserting an inner fitting having a third rib stopper protruding along an outer peripheral surface of an intermediate portion thereof into an end of the coupling pipe, attaching an end of a neighboring coupling pipe of the coupling pipe to the third rib stopper, and disposing the polymer bonder at an outside of the inner fitting and an outside of the neighboring pipe; and (3) moving the fitting cover to attach the fitting cover to an outside of the polymer bonder, applying heat to an outer peripheral surface of the fitting cover to fuse and activate the polymer bonder, and fastening the fitting cover, the coupling pipe, and the neighboring coupling pipe if metal ions on the inner peripheral surface of the fitting cover and the outer peripheral surfaces of the coupling pipe and the neighboring coupling pipe and ions constituting the polymer bond are cooled while being ion-substitution bonded to each other.

Step (1) includes the step of mounting a cylindrical bonder body of the polymer bonder on an outer peripheral surface of an end of the coupling pipe, and attaching the end of the coupling pipe from a periphery of the bonder body to a bonder stopper extending to an inside.

Step (1) further includes winding the polymer bonder, which is a band-shaped bonder tape, on an outer peripheral surface of the end of the coupling pipe a plurality of times in consideration of a difference between an outer diameter of the coupling pipe and an inner diameter of the fitting cover.

Each of the polymer bonders is manufactured by dispersing particles of a polar medium in a Methyl Meta Acrylate (NMA) butadiene rubber based resin.

The polar medium includes one of or at least one combination of Meth-Acrylate (MA), Vinyl Acetate (VA), Maleic Anhydride (MA), and Methyl Meth-Acrylate (NMA).

In step (2), the end of the coupling pipe to which the polymer bonder is coupled is inserted into and attached to a first rib stopper protruding along an inner peripheral surface of the intermediate portion of the fitting cover, and first tapered introduction parts are formed by cutting inner peripheral surfaces of opposite ends of the fitting cover toward the first rib stopper, respectively.

Step (2) further includes attaching and coupling a cylindrical intermediate bushing, opposite ends of which are communicated with each other, to an outer surface of the polymer bonder, and disposing the intermediate bushing at an outside of an end of the coupling pipe, wherein the outer peripheral surfaces of the intermediate bushings are attached to the inner peripheral surface of the fitting cover.

Step (2) further includes adjusting a location of the polymer bonder such that the third rib stopper is disposed inside a central portion of the polymer bonder, wherein a second tapered introduction part is formed by cutting an inner peripheral surface of an end of the fitting cover such that the second tapered introduction part is inclined toward an opposite end of the fitting cover, and wherein a second rib stopper protrudes along an inner peripheral surface of an opposite end of the fitting cover.

A temperature of heat applied to an outer peripheral surface of the fitting cover in step (3) is 220° C. to 300° C.

According to the present invention, the following effects can be achieved.

First, according to the present invention, because a coupling force can be maintained by a polymer bonder ion-substitution bonded to a metal material while being fused and activated between a metallic fitting cover, opposite ends of which are communicated with each other, and a coupling pipe, metallic pipes can be connected at low costs, plastic composite pipes can be easily coupled to each other, and pipes can be used in a high pressure environment.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view showing an entire configuration of a pipe connection apparatus according to an embodiment of the present invention.

FIG. 2 is an exploded sectional concept view showing an entire configuration of a pipe connection apparatus according to an embodiment of the present invention.

FIG. 3 is an exploded sectional concept view showing an entire configuration of a pipe connection apparatus according to another embodiment of the present invention.

FIGS. 4 and 5 are sectional concept views sequentially showing an entire configuration of a pipe connection apparatus and a coupling process thereof according to another embodiment of the present invention.

FIGS. 6 and 7 are concept views showing a polymer bonder which is a main part of a pipe connection apparatus according to other embodiments of the present invention.

### DETAILED DESCRIPTION OF THE EXEMPLARY EMBODIMENTS

Hereinafter, exemplary embodiments of the present invention will be described with reference to the accompanying drawings.

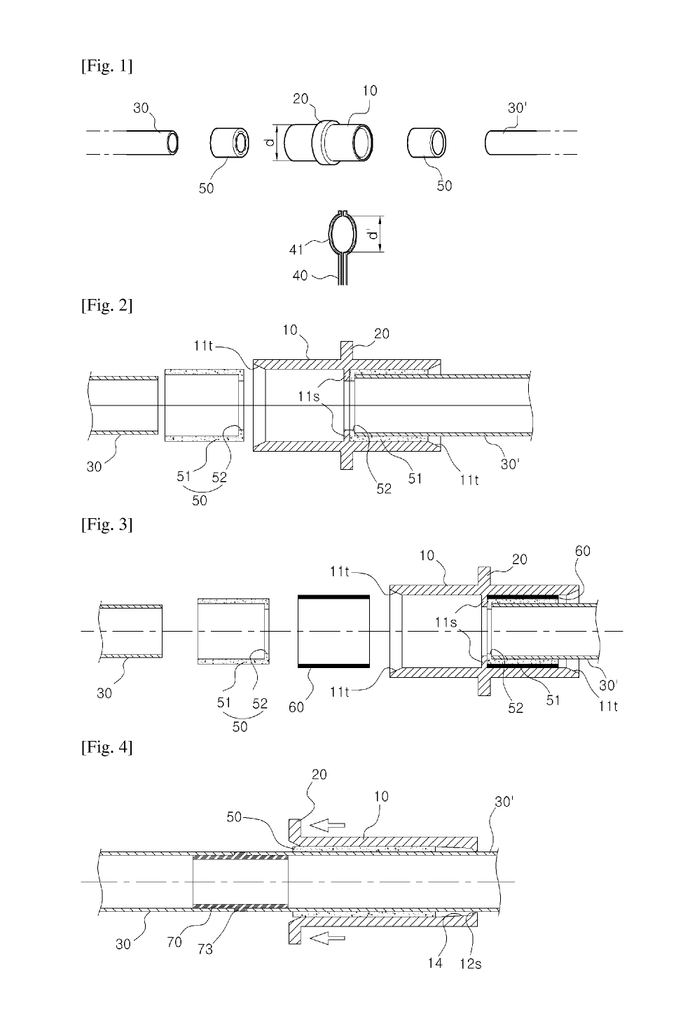

FIG. 1 is an exploded perspective view showing an entire configuration of a pipe connection apparatus according to an embodiment of the present invention. FIG. 2 is an exploded sectional concept view showing an entire configuration of a pipe connection apparatus according to an embodiment of the present invention.

As shown in the drawings, it may be seen that coupling pipes 30 and 30′ are coupled to opposite ends of a fitting cover 10, a cover protrusion 20 is formed in the fitting cover 10, and polymer bonders 50 are disposed between the fitting cover 10 and the coupling pipes 30 and 30′.

The fitting cover 10 is formed of a metal material such that opposite ends thereof communicate with each other, and is provided to mutually connect the coupling pipes 30 and 30′.

The cover protrusion 20 protrudes along an outer peripheral surface of the fitting cover 10 such that the coupling pipes 30 and 30′ can be coupled to each other with a small force when they are fitted with the fitting cover 10, and may be omitted according to the types and coupling tolerances of the coupling pipes 30 and 30′.

Of course, a force may be applied to the cover protrusion 20 using a separate tool such as a wrench or a spanner when it is difficult for an operator to couple the coupling pipes 30 and 30′ through the fitting cover 10 only by hand.

The coupling pipes 30 and 30′ are fitted with opposite ends of the fitting cover 10, a passage is defined between the coupling pipes 30 and 30′ by the fitting cover 10, and the coupling pipes 30 and 30′ have an outer diameter smaller than an inner diameter of the fitting cover 10 and are formed of a composite material of a metal material and a synthetic resin or a metal material.

Here, among the coupling pipes 30 and 30′, one coupling pipe 30 and the other coupling pipe 30′ may be formed of the same material or may be formed of different materials as described above.

Then, of course, the coupling pipe 30 may be used as a connecting pipe and the coupling pipe 30′ may be used as a connecting part such as a refrigerant introduction part of an apparatus such as an air conditioning apparatus, and the coupling pipe 30 and the coupling pipe 30′ may be used commonly for connecting pipes.

The polymer bonders 50 are disposed between the fitting cover 10 and the coupling pipes 30 and 30′, and are fusion-activated to mutually fasten the fitting cover 10 and the coupling pipes 30 and 30′ while being ion-substitution coupled to metal ions of an inner peripheral surface of the fitting cover 10 and outer surfaces of the pipes 30 and 30′.

Accordingly, the present invention can maintain a strong coupling force due to an ion-substitution bond of the polymer bonders 50 even though contact portions of the fitting cover 10 and the coupling pipes 30 and 30′ are not separately machined.

The present invention has the above-described embodiments, and also may have the following various embodiments.

First, prior to a description of the structures of the component elements, the term of an ion-substitution bond for generating a coupling force by the polymer bonders 50 will be defined.

The polymer bonders 50 derive ion substitution between the polymers of the polymer bonders 50, and the metal layers of the fitting cover 10 and the coupling pipes 30 and 30′ while being heated to a temperature of 200° C. to 300° C. through appropriate supply of thermal energy, more specifically, through a heat supply unit 41 of a heating tool 40.

It is preferable that the inner diameter d′ of the heat supply unit 41 is variously provided such that the heat supply unit 41 may be replaced according to the types and environment of constructed pipes, and it is more preferable that the inner diameter d′ of the heat supply unit 41 may correspond to the outer diameter d of the fitting cover 10.

First, a reaction derivative is produced by adsorbing one of or at least one combination of strong acid based materials which are radicals having a strong reactivity and which are activated, that is, Meth-Acrylate (MA), Vinyl Acetate (VA), Maleic Anhydride (MA), and Methyl Meth-Acrylate (NMA) to a rubber based resin which is not decomposed at a high temperature and has a large molecular weight.

Here, the rubber based resin is a Methyl Meta Acrylate (hereinafter, referred to as NMA) butadiene rubber based resin, and the NMA butadiene rubber based resin has a high molecular weight, has a low chemical reactivity, and rarely causes a dual bond or a triple bond.

Thereafter, an outer surface of an NMA butadiene rubber based resin to which a reaction derivative is adsorbed is coated with a non-reactive liquid such as a silicon oil to maintain reactivity for an ion-substitution bond until a polymer and a metal layer are bonded to each other due to a supply of thermal energy.

Continuously, particles are uniformly dispersed in a polymer which is to be bonded and a resin of the same material and are master-batched and enclosed to protect the coated reaction derivative.

If a color is to be coated on a product or a product having a specific function is to be obtained when the product is formed through extrusion or injection-molding using a plastic material, an additive for performing the function should be introduced into the plastic material.

However, because the additive having the function is generally in a powder or liquid state, it is difficult to directly mix the additive with the plastic material and the mixing efficiency becomes lower, so that the master batch is necessary.

The master batch is a pellet type material in which the basic plastic material and the additive are concentrated at a high concentration and dispersed, and if the basic plastic material and the master batch are mixed together and formed, a product having a desired color or function can be obtained.

In order to increase a reaction ratio of the reaction derivative, that is, an activation state, modification is necessary such that polarity groups coincide with each other to minimize a Van Der Waals repulsive force between carbon ions (C—) of main chains of the polymer resin and metal ions (M+) on the surfaces of the fitting cover 10 and the coupling pipes 30 and 30′ which are formed of a metal material.

The functional material introduced in the modification process, that is, the polarity medium mainly includes Meta Acrylate (MA), Vinyl Acetate (VA), Maleic Anhydride (MA), and Methyl Meta Acrylate (NMA).

Then, with the use of a rubber having a high molecular weight which cannot be easily modified in a high temperature reactor, a graft polymerization method which can simultaneously realize radical polymerization and metal ion copolymerization on olefin and a co-monomer having a polarity group is used.

The graft polymer produced by the graft polymerization has a structure in which a monomer B is bonded to salt A having a high molecular weight.

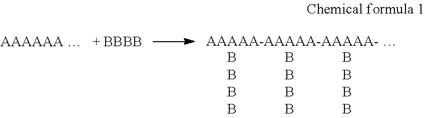

If a polar monomer (mainly methyl meta acrylate) is introduced through a reaction extrusion method using an extruder, it is extruded while being grafted to a main chain as in Chemical formula 2.

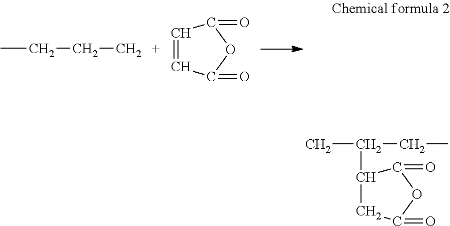

In the copolymerization of metal ions, a bonding structure as in Chemical formula 3 can be derived.

Then, water and hydrogen ions produced in the copolymerization process of metal ions should be removed, and the polymer bonders 50 manufactured in this way are brought into a fusion activation state by thermal energy of an appropriate degree.

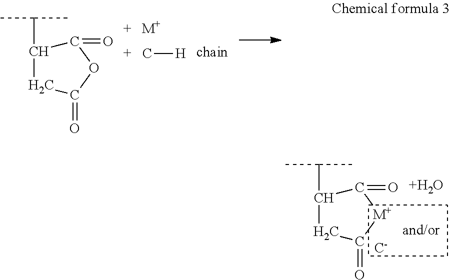

Generally, a surface of a metal has a regular crystal structure, and an aperture of an atomic bond in which an ion bond may be partially performed is present on the surface of the metal.

Accordingly, even though the surfaces of the fitting cover 10 and the coupling pipes 30 and 30′ are formed of a metal, a strong bond in which ions are exchanged while the metal is bonded to the polymer ions (unsaturated polymer chains) can be produced.

That is, an ion-substitution bond is formed as unstable ions in an unsaturated state are adsorbed when carbon ions corresponding to polymer chains are bonded to a part where hydrogen ions are separated from a polymeric carbon main chain based on carbon.

The bond may be a type of a covalent bond, but is referred to as an ion-substitution bond to emphasize that the bond is a stronger level of bond.

Accordingly, the ion-substitution bond has energy of a level of a general molecular bond, and maintains a strong bond state between a polymer and a metal through a strong bonding force.

Meanwhile, as described above, the fitting cover 10 is adapted to connect the coupling pipes 30 and 30′ and it is preferable that the fitting cover 10 is formed of a material having durability, an anti-corrosion property, an anti-low temperature property, and an anti-pressure property. In detail, the fitting cover 10 may be formed of one of or at least one combination of aluminum, an aluminum alloy, copper, a copper alloy, titanium, a titanium alloy, steel, a steel alloy, magnesium, and a magnesium alloy.

Here, as shown in FIGS. 1 and 2, the cover protrusion is formed at an intermediate portion of the fitting cover 10, and the coupling pipes 30 and 30′ are inserted into the fitting cover 10 from opposite ends of the fitting cover 10 and the polymer bonders 50 are coupled to ends of the coupling pipes 30 and 30′ and are inserted from opposite ends of the fitting cover 10.

Then, it is preferable that first tapered introduction parts 11t, in which the inner peripheral surfaces of the opposite ends of the fitting cover 10 are cut away to be inclined toward the cover protrusion 20 such that the coupling pipes 30 and 30′ are easily inserted into the fitting cover 10, are further formed in the fitting cover 10.

A first rib stopper 11s, disposed at a location corresponding to the cover protrusion 20 and protruding along an inner peripheral surface of the fitting cover 10 such that the coupling pipes 30 and 30′ are prevented from further progressing into the fitting cover 10 if the coupling pipes 30 and 30′ are completely inserted into the fitting cover 10, is further formed in the fitting cover 10.

The height by which the first rib stopper 11s protrudes from the inner peripheral surface of the fitting cover 10 may be sufficient as long as it does not interfere with flows of a fluid.

Because the fitting cover 10 may be vulnerable to corrosion when it is manufactured of aluminum or an aluminum alloy, it is preferable that an outer surface of the fitting cover 10 having the cover protrusion 20 is anodized or plated.

This is because a complete coupling, between the fitting cover 10 and the coupling pipes 30 and 30′ may be interrupted when the inner surface of the fitting cover 10 to which the polymer bonders 50 are fused and ion-substitution bonded, is anodized or plate.

Accordingly, after the fitting cover 10 is die-casted of aluminum or an aluminum alloy, only an outer surface and peripheries of opposite ends of the fitting cover 10 which are exposed to an external environment are anodized or plated to form a protective film and the first tapered introduction parts 11t and the first rib stopper 11s are directly machined.

Meanwhile, the coupling pipes 30 and 30′, which are coupled to the fitting cover 10, are metal pipes formed of copper, a copper alloy, aluminum, an aluminum alloy, steel, a steel alloy, titanium, a titanium alloy, magnesium, a magnesium alloy, and a combination thereof, or general plastic pipes formed of a polymer material such as polyethylene, or multilayered composite pipes formed of a metal and plastic.

As described above, the polymer bonders 50 are adapted to couple the fitting cover 10 and the coupling pipes 30 and 30′ while being fused by thermal energy, and it can be seen from FIGS. 1 and 2 that each of the polymer bonders 50 includes a cylindrical bonder body 51 surrounding an end of the corresponding coupling pipe 30 and opposite ends of which are communicated with each other, and a bonder stopper 52 extending from a periphery of an end of the bonder body 51 such that an end of the corresponding coupling pipe 30 is caught by and fixed to the bonder stopper 52.

Hereinafter, a method of connecting pipes using the pipe connection apparatus according to the embodiment of the present invention will be sequentially described.

In step S1, an operator performs an operation of coupling the polymer bonders 50 to ends of the coupling pipe 30 on one side and the coupling pipe 30′ on the other side.

Because an end of a cut pipe may be irregular or have residue thereon, ends of the cut coupling pipes 30 and 30′ may be finished by a tool such as sandpaper or a file in advance.

Then, step S1 includes a process of mounting the bonder bodies 51 of the polymer bonder 50, which is cylindrical, on the outer peripheral surfaces of the ends of the coupling pipes 30, and attaching ends of the coupling pipes 30 from the peripheries of the ends of the bonder bodies 51 to the bonder stopper 52 extending to the inside.

Next, in step S2, the operator performs an operation of inserting ends of the coupling pipes 30 to which the polymer bonders 50 are coupled into opposite ends of the fitting cover 10 which are metallic and communicated with each other and attaching the polymer bonders 50 between the outer peripheral surfaces of the coupling pipes 30 and the fitting cover 10.

Then, in step S2, the operator attaches the ends of the coupling pipes 30, to which the polymer bonders 50 are coupled, to the first rib stopper 11s protruding along an inner peripheral surface of the intermediate portion of the fitting cove r10.

Continuously, in step S3, the operator performs an operation of applying heat to the outer surface of the fitting cover 10 to a temperature of 220° C. to 300° C. through the heat supply unit 41 of the heating tool 40 to fuse the polymer bonders 50.

Thereafter, if the metal ions on the inner peripheral surface of the fitting cover 10 and the outer peripheral surfaces of the coupling pipes 30 and the ions constituting the polymer bonders 50 are cooled while being ion-substitution bonded to each other, the fitting cover 10 and the coupling pipes 30 are coupled to each other.

Meanwhile, of course, when various pipes which are not standardized are coupled in the field, that is, a coupling error between the inner diameter of the fitting cover 10 and the outer diameters of the coupling pipes 30 and 30′ is severe, the pipe connection apparatus according to the embodiment of the present invention may interpose a bush type intermediate bushing 60 having a predetermined thickness between the fitting cover 10 and the polymer bonders 50 as shown in FIG. 3.

The intermediate bushing 60 is attached and coupled to the outer surface of the polymer bonder 50, and the outer peripheral surface of the intermediate bushings 60 is attached to an inner peripheral surface of the fitting cover 10.

The operator may prepare intermediate bushings 60 having various thicknesses in advance in consideration of the aspect.

The intermediate bushings 60 may be inserted with a marginal tolerance without applying a force such that the polymer bonders 50 are completely attached to the ends of the coupling pipes 30 and 30′.

Because aluminum is inexpensive, is excellently ion-substitution bonded to the polymer bonders 50, and is easily plasticized, it is suitable for a material of the intermediate bushings 60.

Here, because an operation of pulling and coupling the fitting cover 10 to a connection portion of the coupling pipes 30 and 30′ requires a considerable force due to a coupling tolerance error due to the first and second embodiments in which the intermediate bushings are not present, it is preferable that a separate dedicated tool is used in the embodiment of FIG. 3.

It will be appreciated by those skilled in the art that after the coupling pipe 30 is fixed, the cover protrusion of the fitting cover 10 is gripped by the tool to be pulled toward the coupling pipe 30 and is coupled to the coupling pipe 30.

In particular, it is apparent that the embodiment of FIG. 3 may be utilized to increase coupling strength in coupling of pipes in an especially high pressure environment in which a commercial pressure is 100 kgf/cm² as well as an environment in which an outer diameter error of the pipe, which is not standardized, is severe.

That is, because a layer of the intermediate bushing layer 60 increases a coupling strength between the fitting cover 10 and the coupling pipes 30 and 30′, a pipe connection apparatus which can be used in an especially high pressure environment can be realized by adding a mechanical coupling effect to the ion-substitution bond by the polymer bonders 50.

Accordingly, in a sequential description of the method of connecting pipes using the pipe connection apparatus according to the embodiments of FIG. 3, step S1 and step S3 are generally the same as the embodiments of FIGS. 1 and 2 and step 2 is different.

That is, a process of attaching and coupling the cylindrical intermediate bushings 60, opposite ends of which are communicated with each other, to outer surfaces of the polymer bonders 50 coupled to the outer peripheral surfaces of the ends of the coupling pipes 30 and 30′ and disposing the intermediate bushings 60 to the outsides of the ends of the coupling pipes 30 is further performed.

Thereafter, step S3 is performed after the coupling pipes 30 and 30′ are inserted into and attached and fixed to the fitting cover 10 while the intermediate bushings 60 are coupled.

Accordingly, because the coupling pipes 30 and 30′ are inserted into and coupled to the opposite ends of the fitting cover 10 in the embodiments of FIGS. 1 to 3, the fitting cover 10 may be manufactured in a linear cylindrical structure, in an elbow form in which the fitting cover is bent at 45 degrees or 90 degrees, or in T form in which three coupling pipes are connected to each other, in various applications and modifications.

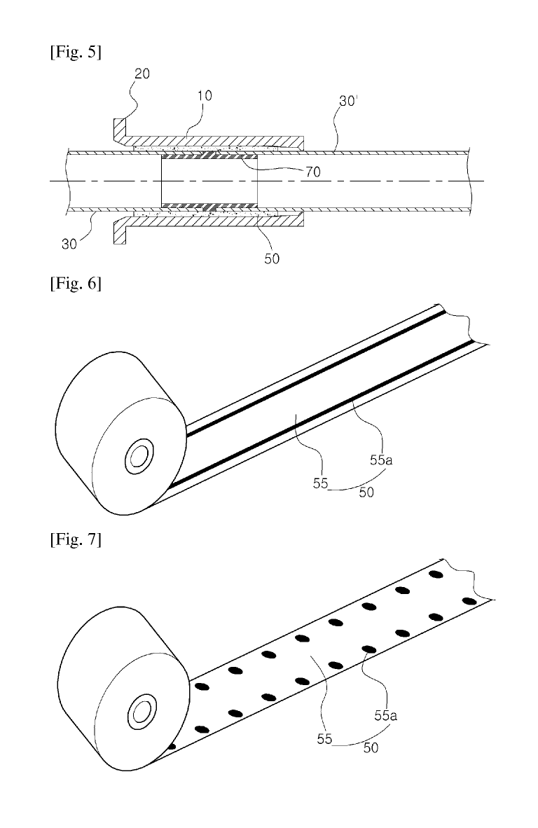

Meanwhile, it is apparent that an embodiment of a structure which further includes an inner fitting 70 to manufacture the polymer bonder 50 in the form of a single bush and to increase bending moment as shown in FIGS. 4 and 5 may be applied to the present invention.

That is, the cover protrusion 20 is formed at one end of the fitting cover 10, the coupling pipes 30 are inserted into the fitting cover 10 from opposite ends of the fitting cover 10 and are coupled to the fitting cover 10, and the polymer bonders 50 surround the outer peripheral surfaces of the ends of the coupling pipes 30 and 30′.

Here, the fitting cover 10 further includes a second tapered introduction part 12t formed by cutting an inner peripheral surface of one end of the fitting cover 10 such that the second tapered introduction part 12t is inclined toward the cover protrusion 20, and a second rib stopper 12s protruding along an inner peripheral surface of an opposite end of the fitting cover 10.

Then, it is preferable that a tapered coupling part 14 formed to be inclined from the second rib stopper 12s toward one end of the fitting cover 10 such that the polymer bonder 50 is attached and fixed to an inner peripheral surface of the fitting cover 10 is further formed on the inner peripheral surface of the fitting cover 10.

The inner fitting 70 includes a third rib stopper 73 connecting facing ends of the coupling pipes 30 and 30′ and protruding along an outer peripheral surface of an intermediate portion of the inner fitting 70.

Unlike the embodiments of FIGS. 1 to 3, in the embodiments of FIGS. 4 and 5, an inner fitting 70 is used in an environment in which it is necessary to increase a resistance force against bending in a connection portion of a direct pipe or coupling pipes.

A pipe connection method using the pipe connection apparatus according to the embodiments of FIGS. 4 and 5 will be sequentially described over three steps.

In step S1, as shown in FIG. 4, an operation of passing the metallic fitting cover 10 through an end of the coupling pipe 30′ on the other side and coupling the polymer bonder 50 to an end of the coupling pipe 30′ on the other side is performed.

In step S2, the operator performs an operation of inserting the inner fitting 70 including the third rib stopper 73 protruding along an outer peripheral surface of the intermediate portion of the inner fitting 70 into an end of the coupling pipe 30′ on the other side, attaching and connecting an end of the neighboring coupling pipe 30 of the coupling pipe 30′ on the opposite side, and disposing the polymer bonders 50 at the outside of the inner fitting 70 and the outsides of the coupling pipes 30 and 30′ along an arrow direction of FIG. 4 as shown in FIG. 5.

Then, it is preferable that in step S2, the operator adjusts a location of the polymer bonder 50 such that the third rib stopper 73 is disposed at an inside of a central portion of the polymer bonder 50.

In step S3, the operator performs an operation of moving the fitting cover 10, attaching the fitting cover 10 to an outside of the polymer bonder 50, applying heat to an outer peripheral surface of the fitting cover 10, and fusing and activating the polymer bonder 50.

Thereafter, if the metal ions on the inner peripheral surface of the fitting cover 10 and the outer peripheral surfaces of the coupling pipes 30 on one side and the coupling pipe 30′ on the other side and the ions constituting the polymer bonders 50 are cooled while being ion-substitution bonded to each other, the fitting cover 10 and the coupling pipes 30 and 30′ are coupled to each other.

Meanwhile, the polymer bonder 50 may have a shape in which the bonder stopper 52 is provided in the bonder body as shown in FIGS. 1 to 3, may be provided in the form of a cylindrical premade product as shown in FIGS. 4 and 5, and may be provided in the form of a band-shaped bonder tape 55 which is wound on inner peripheral surfaces of the coupling pipes 30 and 30′ a plurality of times as shown in FIGS. 6 and 7.

The bonder tape 55 is manufactured in the form of a seal tape such that the operator may wind the bonder tape on the coupling pipes 30 and 30′ within a designated range.

Although the bonder tape 55 is standardized according to the field and construction environment to which the diameters of the coupling pipes 30 and 30′ are applied, it has a tolerance according to the manufacturers, and when the tolerance is severe, the operator measures the outer diameters of the coupling pipes 30 and 30′ in advance and coupling force is lowered as the thickness of the polymer bonder 50 becomes thicker, and accordingly, the tolerance may be covered by determining the thickness of the polymer bonder 50 in consideration of the number of windings of the bonder tapes 55.

The bonder tape 55 may be applied to all of the embodiments of FIGS. 1 to 5, and it is preferable that the bonder tape 55 is formed in a line along the lengthwise direction of the bonder tape 55 as shown in FIG. 5 or an adhesive layer 55a has a plurality of points as shown in FIG. 6 in order to maintain a state in which the bonder tape 55 is wound on outer surfaces of the coupling pipes 30 and 30′.

Meanwhile, it is preferable that an area in which the adhesive layer 55a is formed is minimized because it is sufficient as long as the bonder tape 55 maintains a state in which the bonder tape 55 is wound on outer surfaces of the coupling pipes 30 and 30′ instead of forming the adhesive layer 55a over an entire area of the bonder tape as the adhesive layer 55a may interrupt an ion-substitution bond of the polymer bonder 50.

Accordingly, in the pipe connection methods according to the first to fifth embodiments of the present invention, because the operator performs an operation of winding the polymer bonder 50 in the form of a bonder tape 55 on the outer surfaces of the coupling pipes 30 and 30′ in step S1, the operation of coupling the polymer bonder 50 to the coupling pipes 30 and 30′ can be replaced.

That is, in step S1, a process of winding the polymer bonder 50, which is a band-shaped bonder tape 55, on an outer peripheral surface of an end of the coupling pipe 30 a plurality of times is further performed in consideration of a difference between the outer diameters of the coupling pipes 30 and 30′ and the inner diameter of the fitting cover 10.

As described above, the basic technical spirit of the present invention is a pipe connection apparatus and a pipe connection method in which metallic pipes are connected by using a polymer bonder which is inexpensive and ion-substitution bonded to a metal material and plastic complex pipes are easily coupled to each other, and which can be used in a high pressure environment.

It will be appreciated that various modifications and applications can be made by those skilled in the art without departing from the basic technical spirit of the present invention.

1. A pipe connection apparatus comprising:
a metallic fitting cover, opposite ends of which are communication with each other;
a cover protrusion protruding along an outer peripheral surface of the fitting cover;
coupling pipes inserted into opposite ends of the fitting cover, respectively, passages of which are connected to each other by the fitting cover, having an outer diameter smaller than an inner diameter of the fitting cover, and formed of a composite material of a metal and a synthetic resin or a metal; and
polymer bonders disposed between the fitting cover and the coupling pipes, respectively, for fastening the fitting cover and the coupling pipes while being fused to be activated such that ions of the polymer bonders are ion-substitution bonded to metal ions on an inner peripheral surface of the fitting cover and outer surfaces of the coupling pipes.

2. The pipe connection apparatus of claim 1, wherein the cover protrusion is formed at an intermediate portion of the fitting cover, the coupling pipes are inserted into the fitting cover from opposite ends of the fitting cover and are coupled to the fitting cover, and the polymer bonders are coupled to ends of the coupling pipes and are inserted into the fitting cover from the opposite ends of the fitting cover.

3. The pipe connection apparatus of claim 2, further comprising first tapered introduction parts formed by cutting inner peripheral surfaces of opposite ends of the fitting cover such that the first tapered introduction parts are inclined toward the cover protrusion.

4. The pipe connection apparatus of claim 2, wherein the fitting cover further comprises a first rib stopper disposed at a location corresponding to the cover, protrusion and protruding along an inner peripheral surface of the fitting cover.

5. The pipe connection apparatus of claim 2, wherein each of the polymer bonders comprises:
a cylindrical bonder body surrounding an end of the corresponding coupling pipe and opposite ends of which are communicated with each other; and
a bonder stopper extending from a periphery of an end of the bonder body such that an end of the corresponding coupling pipe is caught by and fixed to the bonder stopper.

6. The pipe connection apparatus of claim 2, further comprising intermediate bushings attached and coupled to an outer surface of the polymer bodies, wherein the outer peripheral surfaces of the intermediate bushings are attached to the inner peripheral surface of the fitting cover.

7. The pipe connection apparatus of claim 1, wherein the cover protrusion is formed at an end of the fitting cover, the coupling pipes are inserted into the fitting cover from opposite ends of the fitting cover and are coupled to the fitting cover, and the polymer bonders are coupled to surround outer peripheral surfaces of the coupling pipes, respectively.

8. The pipe connection apparatus of claim 7, further comprising:
a second tapered part formed by cutting an inner peripheral surface of one end of the fitting cover such that the second tapered part is inclined toward the cover protrusion; and
a second rib stopper protruding along an inner peripheral surface of an opposite end of the fitting cover.

9. The pipe connection apparatus of claim 7, further comprising:
an inner fitting connecting ends of the coupling pipes which face each other and comprising a third rib stopper protruding along an outer peripheral surface of the intermediate portion.

10. The pipe connection apparatus of claim 1, wherein in each of the polymer bonders, particles of a polar medium are dispersed in a Methyl Meta Acrylate (NMA) butadiene rubber based resin.

11. The pipe connection apparatus of claim 10, wherein the polar medium comprises one of or at least one combination of Meth-Acrylate (MA), Vinyl Acetate (VA), Maleic Anhydride (MA), and Methyl Meth-Acrylate (NMA).

12. The pipe connection apparatus of claim 2, wherein the polymer bonders are band-shaped bonder tapes wound on outer peripheral surfaces of the coupling pipes a plurality of times.

13. The pipe connection apparatus of claim 12, wherein each of the polymer bonders further comprises an adhesive layer having at least one line or a plurality of points formed along a lengthwise direction of the bonder tape.

14. The pipe connection apparatus of claim 1, wherein the fitting cover comprises one of or at least one combination of aluminum, an aluminum alloy, copper, a copper alloy, titanium, a titanium alloy, steel, a steel alloy, magnesium, and a magnesium alloy.

15. A pipe connection method comprising the steps of:
(1) coupling polymer bonders to ends of a coupling pipe;
(2) inserting the ends of the coupling pipes to which the polymer bonders are coupled into opposite ends of a metallic fitting cover, ends of which are communicated with each other, and attaching the polymer bonders between outer peripheral surfaces of the coupling pipes and an inner peripheral surface of the fitting cover; and
(3) fusing and activating the polymer bonders by applying heat to an outer peripheral surface of the fitting cover, and fastening the fitting cover and the coupling pipes if metal ions on the inner surface of the fitting cover and the outer peripheral surfaces of the coupling pipes and ions constituting the polymer bonders are ion-substitution bonded to each other.

16. A pipe connection method comprising the steps of:
(1) passing a metallic fitting cover through an end of a coupling pipe, and coupling a polymer bonder to an end of the coupling pipe;
(2) inserting an inner fitting having a third rib stopper protruding along an outer peripheral surface of an intermediate portion thereof into an end of the coupling pipe, attaching an end of a neighboring coupling pipe of the coupling pipe to the third rib stopper, and disposing the polymer bonder at an outside of the inner fitting and an outside of the neighboring pipe; and
(3) moving the fitting cover to attach the fitting cover to an outside of the polymer bonder, applying heat to an outer peripheral surface of the fitting cover to fuse and activate the polymer bonder, and fastening the fitting cover, the coupling pipe, and the neighboring coupling pipe if metal ions on the inner peripheral surface of the fitting cover and the outer peripheral surfaces of the coupling pipe and the neighboring coupling pipe and ions constituting the polymer bond are cooled while being ion-substitution bonded to each other.

17. The pipe connection method of claim 15, wherein step (1) comprises the step of mounting a cylindrical bonder body of the polymer bonder on an outer peripheral surface of an end of the coupling pipe, and attaching the end of the coupling pipe from a periphery of the bonder body to a bonder stopper extending to an inside.

18. The pipe connection method of claim 15, wherein step (1) further comprises winding the polymer bonder, which is a band-shaped bonder tape, on an outer peripheral surface of the end of the coupling pipe a plurality of times in consideration of a difference between an outer diameter of the coupling pipe and an inner diameter of the fitting cover.

19. The pipe connection method of 15, wherein each of the polymer bonders is manufactured by dispersing particles of a polar medium in a Methyl Meta Acrylate (NMA) butadiene rubber based resin.

20. The pipe connection method of claim 19, wherein the polar medium comprises one of or at least one combination of Meth-Acrylate (MA), Vinyl Acetate (VA), Maleic Anhydride (MA), and Methyl Meth-Acrylate (NMA).

21. The pipe connection method of claim 15, wherein in step (2), the end of the coupling pipe to which the polymer bonder is coupled is inserted into and attached to a first rib stopper protruding along an inner peripheral surface of the intermediate portion of the fitting cover, and first tapered introduction parts are formed by cutting inner peripheral surfaces of opposite ends of the fitting cover toward the first rib stopper, respectively.

22. The pipe connection method of claim 21, wherein step (2) further comprises attaching and coupling a cylindrical intermediate bushing, opposite ends of which are communicated with each other, to an outer surface of the polymer bonder, and disposing the intermediate bushing at an outside of an end of the coupling pipe, wherein the outer peripheral surfaces of the intermediate bushings are attached to the inner peripheral surface of the fitting cover.

23. The pipe connection method of claim 16, wherein step (2) further comprises adjusting a location of the polymer bonder such that the third rib stopper is disposed inside a central portion of the polymer bonder, wherein a second tapered introduction part is formed by cutting an inner peripheral surface of an end of the fitting cover such that the second tapered introduction part is inclined toward an opposite end of the fitting cover, and wherein a second rib stopper protrudes along an inner peripheral surface of an opposite end of the fitting cover.

24. The pipe connection method of claim 15, wherein a temperature of heat applied to an outer peripheral surface of the fitting cover in step (3) is 220° C. to 300° C.

25. The pipe connection apparatus of claim 7, wherein the polymer bonders are band-shaped bonder tapes wound on outer peripheral surfaces of the coupling pipes a plurality of times.

26. The pipe connection method of claim 16, wherein step (1) further comprises winding the polymer bonder, which is a band-shaped bonder tape, on an outer peripheral surface of the end of the coupling pipe a plurality of times in consideration of a difference between an outer diameter of the coupling pipe and an inner diameter of the fitting cover.

27. The pipe connection method of claim 16, wherein each of the polymer bonders is manufactured by dispersing particles of a polar medium in a Methyl Meta Acrylate (NMA) butadiene rubber based resin.

28. The pipe connection method of claim 27, wherein the polar medium comprises one of or at least one combination of Meth-Acrylate (MA), Vinyl Acetate (VA), Maleic Anhydride (MA), and Methyl Meth-Acrylate (NMA).

29. The pipe connection method of claim 16, wherein a temperature of heat applied to an outer peripheral surface of the fitting cover in step (3) is 220° C. to 300° C.
